(19) United States
(12) Patent Application Publication
(10) Pub. No.: US 2025/0206925 A1
(43) Pub. Date: Jun. 26, 2025

(54) TIRE

(71) Applicant: SUMITOMO RUBBER INDUSTRIES, LTD., Kobe-shi, Hyogo (JP)

(72) Inventor: Yamato ICHIMOTO, Kobe-shi (JP)

(73) Assignee: SUMITOMO RUBBER INDUSTRIES, LTD., Kobe-shi, Hyogo (JP)

(21) Appl. No.: 18/843,560

(22) PCT Filed: Feb. 17, 2023
(86) PCT No.: PCT/JP2023/005720

§ 371 Date: Sep. 3, 2024

(30) Foreign Application Priority Data
Mar. 7, 2022 (JP) 2022-034506

(51) Int. Cl. C08L 15/00; B60C 1/00; B60C 11/00; B60C 11/03; C08K 5/098

(52) U.S. Cl. CPC C08L 15/00; B60C 1/0016; B60C 11/0008; C08K 5/098; B60C 2011/0025; B60C 2011/0341

(57) ABSTRACT

The present disclosure provides a tire that has both excellent wet grip performance and excellent dry grip performance. The tire of the present disclosure includes a tread with at least one circumferential groove, the circumferential groove being formed of a groove-forming rubber composition, E* (MPa) when wet with water, E* (MPa) when dry, tan δ when wet with water, and tan δ when dry of the groove-forming rubber composition and groove depth D (mm) of the circumferential groove satisfying at least one of the following formula (1-1) or the following formula (1-2) as well as the following formula (2):

$$E * when wet with water / E * when dry \leq 0.9 \qquad ( 1 - 1 )$$

$$tan δ when wet with water / tan δ when dry \geq 1.1 \qquad ( 1 - 2 )$$

$$D / ( E * when wet with water / E * when dry ) > 9. \qquad ( 2 )$$

where E* and tan δ represent a complex modulus of elasticity (MPa) and a loss tangent, respectively, after 30 minutes from the start of measurement under the conditions of a temperature of 30° C., an initial strain of 10%, a dynamic strain of 1%, a frequency of 10 Hz, an elongation mode, and a measurement duration of 30 minutes, and D represents the groove depth (mm) of the circumferential groove.

### TECHNICAL FIELD

The present disclosure relates to a tire.

### BACKGROUND ART

In recent years, safety has become an increasingly important issue for all automobiles. This issue has created a need for further improvement in wet grip performance and handling stability. Various studies have been made to improve wet grip performance, and a variety of disclosures directed to silica-containing rubber compositions have been reported (for example, Patent Literature 1). Wet grip performance may be greatly affected particularly by the performances of the rubber composition of the tread portion that contacts the road. Thus, a wide range of technical improvements in rubber compositions for tire components such as treads have been proposed and put into practical use.

### CITATION LIST

### Patent Literature

Patent Literature 1: JP 2008-285524 A SUMMARY OF DISCLOSURE

### Technical Problem

Although the wet grip performance of tires has greatly advanced with improved silica-containing rubber compositions for treads, there still remains the issue of changes in grip performance caused by, for example, changes in road conditions from dry to wet road surface or from wet to dry road surface, as a major technical problem. Thus, room for improvement exists.

As described above, the conventional techniques leave room for improvement in achieving both excellent wet grip performance and excellent dry grip performance.

The present disclosure aims to solve the above-described problem and provide a tire that has both excellent wet grip performance and excellent dry grip performance.

### Solution to Problem

The present disclosure relates to a tire, including a tread with at least one circumferential groove,
the circumferential groove being formed of a groove-forming rubber composition,
E* (MPa) when wet with water, E* (MPa) when dry, tan δ when wet with water, and tan δ when dry of the groove-forming rubber composition and groove depth D (mm) of the circumferential groove satisfying at least one of the following formula (1-1) or the following formula (1-2) as well as the following formula (2):

$$E * when wet with water / E * when dry \leq 0.9 \qquad ( 1 - 1 )$$

$$tan δ when wet with water / tan δ when dry \geq 1.1 \qquad ( 1 - 2 )$$

$$D / ( E * when wet with water / E * when dry ) > 9. \qquad ( 2 )$$

where E* and tan δ represent a complex modulus of elasticity (MPa) and a loss tangent, respectively, after 30 minutes from the start of measurement under the conditions of a temperature of 30° C., an initial strain of 10%, a dynamic strain of 1%, a frequency of 10 Hz, an elongation mode, and a measurement duration of 30 minutes, and D represents the groove depth (mm) of the circumferential groove.

### ADVANTAGEOUS EFFECTS OF DISCLOSURE

The tire according to the present disclosure has the above-described structure. The tire can have both excellent wet grip performance and excellent dry grip performance.

### BRIEF DESCRIPTION OF DRAWINGS

FIG. 1 shows a cross-sectional view of a part of a pneumatic tire 2.

FIG. 2 shows an enlarged cross-sectional view of a tread 4 and its vicinity of the tire 2 in FIG. 1.

### DESCRIPTION OF EMBODIMENTS

The tire of the present disclosure includes a tread with at least one circumferential groove. The circumferential groove is formed of a groove-forming rubber composition. E* (MPa) when wet with water, E* (MPa) when dry, tan δ when wet with water, and tan δ when dry of the groove-forming rubber composition and groove depth D (mm) of the circumferential groove satisfy at least one of the following formula (1-1) or the following formula (1-2) as well as the following formula (2). This tire can have both excellent wet grip performance and excellent dry grip performance.

$$E * when wet with water / E * when dry \leq 0.9 \qquad ( 1 - 1 )$$

$$tan δ when wet with water / tan δ when dry \geq 1.1 \qquad ( 1 - 2 )$$

$$D / ( E * when wet with water / E * when dry ) > 9. \qquad ( 2 )$$

In the formulas, E* and tan δ represent a complex modulus of elasticity (MPa) and a loss tangent, respectively, after 30 minutes from the start of measurement under the conditions of a temperature of 30° C., an initial strain of 10%, a dynamic strain of 1%, a frequency of 10 Hz, an elongation mode, and a measurement duration of 30 minutes, and D represents the groove depth (mm) of the circumferential groove.

The problem (aim) of the present disclosure is to achieve both excellent wet grip performance and excellent dry grip performance. The problem is solved by developing a tire including a tread with at least one circumferential groove, the circumferential groove being formed of a groove-forming rubber composition, E* (MPa) when wet with water, E* (MPa) when dry, tan δ when wet with water, and tan δ when dry of the groove-forming rubber composition and groove depth D (mm) of the circumferential groove satisfying at least one of the formula (1-1) or the formula (1-2) as well as the formula (2). In other words, the essential feature of the present disclosure is a tire including a tread with at least one circumferential groove, wherein the circumferential groove is formed of a groove-forming rubber composition, and E* (MPa) when wet with water, E* (MPa) when dry, tan δ when wet with water, and tan δ when dry of the groove-forming rubber composition and groove depth D (mm) of the circumferential groove satisfy at least one of the formula (1-1) or the formula (1-2) as well as the formula (2).

The reason why the above-described advantageous effect can be achieved is not completely clear, but it is probably due to the following mechanism.

These days, it is not uncommon to drive on a road with a mixture of dry and wet road surfaces because of local rainfall. Drivers have difficulty in instantly judging and responding to the road condition. Therefore, stable wet grip performance is desired regardless of whether the road surface is dry or wet.

The groove-forming rubber composition when wet with water reduces the complex modulus of elasticity by 10% or more (formula (1-1)) and/or increases the loss tangent by 10% or more (formula (1-2)) from the complex modulus of elasticity and/or the loss tangent when it is dry. Therefore, conformity and heat generation can be instantly obtained on a wet road surface. Thus, presumably, excellent grip performance on a wet road surface can be achieved in addition to the dry grip performance. Moreover, the tire of the present disclosure includes a tread with at least one circumferential groove and satisfies the formula (2). The larger the groove depth D of the circumferential groove formed of the groove-forming rubber composition is, the more sufficiently the water between the road surface and the tire can be drained on a wet road surface. Therefore, as the D increases, the value of “E* when wet with water/E* when dry” is reduced to increase the conformity when wet with water, presumably whereby good grip performance can be obtained both on a dry road surface and a wet road surface. As described above, the rubber composition instantly changes its state in driving on a road with a mixture of dry and wet road surfaces to stably exhibit grip performance. Thus, presumably, the tire can achieve both excellent wet grip performance and excellent dry grip performance.

Herein, the complex modulus of elasticity (E*) and the loss tangent (tan δ) of the rubber composition mean the E* and tan δ of the vulcanized rubber composition. The E* and tan δ are determined by viscoelastic testing of the vulcanized rubber composition.

The rubber composition satisfies at least one of the formula (1-1) or the formula (1-2) and reversibly changes the complex modulus of elasticity (E*) and the loss tangent (tan δ) with water. Herein, the expression “reversibly changes the complex modulus of elasticity (E*) and the loss tangent (tan δ) with water” means that the E* and tan δ of the (vulcanized) rubber composition reversibly increase or decrease depending on the presence of water. It is sufficient that the E* and tan δ reversibly change when the state of the rubber composition changes as follows: dry→wet with water→dry, for example. The rubber composition in the former dry state may not have the same E* or tan δ as that in the latter dry state or may have the same E* or tan δ as that in the latter dry state.

Herein, the term “E* and tan δ when dry” means the E* and tan δ, respectively, of the rubber composition which is dry and specifically refers to the E* and tan δ of the rubber composition which has been dried by the method described in EXAMPLES.

Herein, the term “E* and tan δ when wet with water” means the E* and tan δ, respectively, of the rubber composition which is wet with water and specifically refers to the E* and tan δ of the rubber composition which has been wet with water by the method described in EXAMPLES.

Herein, the E* and tan δ of the rubber composition are the E* and tan δ after 30 minutes from the start of the measurement under the conditions of a temperature of 30° C., an initial strain of 10%, a dynamic strain of 1%, a frequency of 10 Hz, an elongation mode, and a measurement duration of 30 minutes.

The rubber composition desirably satisfies the following formula (1-1):

$$E * when wet with water / E * when dry \leq 0.9 \qquad ( 1 - 1 )$$

where E* represents a complex modulus of elasticity (MPa) after 30 minutes from the start of measurement under the conditions of a temperature of 30° C., an initial strain of 10%, a dynamic strain of 1%, a frequency of 10 Hz, an elongation mode, and a measurement duration of 30 minutes.

The value of “E* when wet with water/E* when dry” is preferably 0.87 or less, more preferably 0.86 or less, still more preferably 0.85 or less, further preferably 0.84 or less, further preferably 0.83 or less, further preferably 0.82 or less, further preferably 0.80 or less, further preferably 0.79 or less, further preferably 0.78 or less, further preferably 0.75 or less, particularly preferably 0.70 or less. The lower limit of the value of “E* when wet with water/E* when dry” is not limited, and it is preferably 0.10 or more, more preferably 0.20 or more, still more preferably 0.30 or more, particularly preferably 0.35 or more. When the value is within the range indicated above, the advantageous effect can be suitably achieved.

The E* when dry of the rubber composition is preferably 2.5 MPa or more, more preferably 3.4 MPa or more, still more preferably 3.5 MPa or more, further preferably 3.7 MPa or more, further preferably 3.9 MPa or more, further preferably 4.0 MPa or more, further preferably 4.1 MPa or more, further preferably 4.5 MPa or more, further preferably 4.6 MPa or more, further preferably 4.9 MPa or more, further preferably 5.0 MPa or more, further preferably 5.4 MPa or more, further preferably 5.7 MPa or more, further preferably 7.1 MPa or more. The upper limit of the E* when dry is not limited, and it is preferably 20.0 MPa or less, more preferably 15.0 MPa or less, still more preferably 13.0 MPa or less, particularly preferably 12.0 MPa or less. When the E* when dry is within the range indicated above, the advantageous effect can be suitably achieved.

The rubber composition desirably satisfies the following formula (1-2):

$$tan δ when wet with water / tan δ when dry \geq 1.1 \qquad ( 1 - 2 )$$

where tan δ represents a loss tangent after 30 minutes from the start of measurement under the conditions of a temperature of 30° C., an initial strain of 10%, a dynamic strain of 1%, a frequency of 10 Hz, an elongation mode, and a measurement duration of 30 minutes.

The value of “tan δ when wet with water/tan δ when dry” is preferably 1.15 or more, more preferably 1.17 or more, still more preferably 1.18 or more, further preferably 1.19 or more, further preferably 1.20 or more, further preferably 1.21 or more, further preferably 1.23 or more, further preferably 1.24 or more, further preferably 1.25 or more, particularly preferably 1.30 or more. The upper limit of the value of “tan δ when wet with water/tan δ when dry” is not limited, and it is preferably 1.80 or less, more preferably 1.70 or less, still more preferably 1.65 or less, particularly preferably 1.60 or less. When the value is within the range indicated above, the advantageous effect can be suitably achieved.

The tan δ when dry of the rubber composition is preferably 0.15 or more, more preferably 0.20 or more, still more preferably 0.22 or more, further preferably 0.24 or more, further preferably 0.25 or more, further preferably 0.27 or more, further preferably 0.29 or more, further preferably 0.30 or more, further preferably 0.32 or more, further preferably 0.33 or more, further preferably 0.38 or more. The upper limit of the tan δ when dry is not limited, and it is preferably 6.0 or less, more preferably 5.5 or less, still more preferably 5.2 or less, particularly preferably 5.0 or less. When the tan δ when dry is within the range indicated above, the advantageous effect can be suitably achieved.

The reversible change with water in E* or in tan δ represented by at least one of the formula (1-1) or the formula (1-2) in the rubber composition can be achieved, for example, by adding a modified rubber containing at least one selected from the group consisting of carboxylic acid, sulfonic acid, and salts thereof in its molecule and at least one alkali metal salt or alkaline earth metal salt selected from the group consisting of lithium carbonate, sodium carbonate, potassium carbonate, rubidium carbonate, cesium carbonate, beryllium carbonate, magnesium carbonate, calcium carbonate, strontium carbonate, barium carbonate, lithium acetate, sodium acetate, potassium acetate, rubidium acetate, cesium acetate, beryllium acetate, magnesium acetate, calcium acetate, strontium acetate, barium acetate, lithium phenoxide, sodium phenoxide, potassium phenoxide, rubidium phenoxide, cesium phenoxide, beryllium diphenoxide, magnesium diphenoxide, calcium diphenoxide, strontium diphenoxide, and barium diphenoxide. Specifically, the reversible change with water in E* or in tan δ represented by at least one of the formula (1-1) or the formula (1-2) in the rubber composition can be achieved, for example, by using a combination of a modified rubber containing at least one selected from the group consisting of carboxylic acid, sulfonic acid, and salts thereof in its molecule, such as a carboxylic acid-modified SBR, and an alkali metal salt or alkaline earth metal salt, such as lithium acetate. Owing to the combination, for example, the anion derived from the carboxylic acid, sulfonic acid, or salts thereof and the cation derived from the alkali metal salt or alkaline earth metal salt can form an ionic bond between the modified rubber and the alkali metal salt or alkaline earth metal salt. Then, the ionic bond may be cleaved by adding water and re-formed by drying water. Consequently, the E* decreases and/or the tan δ increases when wet with water, while the E* increases and/or the tan δ decreases when dry. Presumably, the reversible change can be thus achieved.

The E* when dry can be controlled by the types and the amounts of chemicals (in particular, rubber components, fillers, softening agents such as oils) blended in the rubber composition. For example, the E* when dry tends to be increased by reducing the amount of softening agents or increasing the amount of fillers.

The tan δ when dry can be controlled by the types and the amounts of chemicals (in particular, rubber components, fillers, softening agents, resins, sulfur, vulcanization accelerators, or silane coupling agents) blended in the rubber composition. For example, the tan δ when dry tends to be increased by using softening agents (e.g., resin) with low compatibility with rubber components, using unmodified rubbers, increasing the amount of fillers, increasing oils as plasticizers, reducing sulfur, reducing vulcanization accelerators, or reducing silane coupling agents.

The E* and tan δ when dry can be controlled by, for example, varying the acid functional group content of the modified rubber or the amount of the alkali metal salt or alkaline earth metal salt (specifically, the amount of metal derived from the alkali metal salt or alkaline earth metal salt). Specifically, when the acid functional group content of the modified rubber or the amount of the alkali metal salt or alkaline earth metal salt is increased, the E* when dry tends to increase and the tan δ when dry tends to increase.

The E* when wet with water can be reduced and/or the tan δ when wet with water can be increased, as compared to the value when dry, by using the rubber composition in which the modified rubber and the alkali metal salt or alkaline earth metal salt are partly or fully cross-linked by ionic bonds, for example. Thus, the E* and tan δ when wet with water and when dry can be controlled. Specifically, the use of a combination of the modified rubber and the alkali metal salt or alkaline earth metal salt provides a rubber composition in which the rubber and the salt are cross-linked by ionic bonds, and thus the E* when wet with water can be reduced and/or the tan δ when wet with water can be increased as compared to the value when dry. The E* and tan δ when wet with water can be controlled by varying the amounts or the types of the chemicals in the rubber composition. For example, the above-described techniques to control the E* when dry and the tan δ when dry can cause the above-described tendencies also in the E* and tan δ when wet with water.

Further, specifically, the reversible change with water in E* and/or tan δ represented by at least one of the formula (1-1) or the formula (1-2) in the rubber composition can be achieved by controlling the E* and tan δ when dry to fall within the predetermined ranges and then using a combination of the modified rubber containing at least one selected from the group consisting of carboxylic acid, sulfonic acid, and salts thereof in its molecule and the alkali metal salt or alkaline earth metal salt.

### (Rubber Component)

The rubber composition preferably contains, as a rubber component, a modified rubber containing at least one selected from the group consisting of carboxylic acid (carboxylic acid group (—COOH)), sulfonic acid (sulfuric acid group (—SO₃H)), and salts thereof (salts consisting of at least one of carboxylic acid ion (—COO—) or sulfonic acid ion (—SO—) and a counter cation of the ion) in its molecule. Non-limiting examples of the salts include monovalent metal salts such as alkali metal salts (sodium salt, potassium salt, etc.) and divalent metal salts such as alkaline earth metal salts (calcium salt, strontium salt, etc.). In order to better achieve the advantageous effect, a carboxylic acid group is preferred, a (meth)acrylic acid group and a maleic acid group are more preferred, and a methacrylic acid group and a maleic acid group are particularly preferred among these.

The modified rubber contains an ionic functional group 1 that is at least one selected from the group consisting of carboxylic acid, sulfonic acid, and salts thereof in its molecule. The amount of the ionic functional group 1 based on 100% by mass of the rubber (based on 100% by mass of the rubber containing the ionic functional group 1 in its molecule) is preferably 0.5% by mass or more, more preferably 0.8% by mass or more, still more preferably 1.0% by mass or more, further preferably 5.0% by mass. The upper limit is not limited, and it is preferably 40% by mass or less, more preferably 35% by mass or less.

The amount of the ionic functional group 1 can be measured by performing NMR analysis and then calculating the amount (% by mass) from the peak corresponding to the ionic functional group 1.

The amount of the modified rubber based on 100% by mass of the rubber component in the rubber composition is preferably 5% by mass or more, more preferably 20% by mass or more, still more preferably 40% by mass or more, particularly preferably 50% by mass or more. The upper limit is not limited, and it is preferably 90% by mass or less, more preferably 85% by mass or less, still more preferably 80% by mass or less, particularly preferably 75% by mass or less. When the amount is within the range indicated above, the advantageous effect can be suitably achieved.

In order to suitably achieve the advantageous effect, the rubber constituting the backbone of the modified rubber preferably contains at least one monomer selected from the group consisting of styrene, butadiene, and isoprene as a structural unit. Specific examples of the rubber include isoprene-based rubbers, polybutadiene rubber (BR), styrene-butadiene rubber (SBR), and styrene-isoprene-butadiene rubber (SIBR). The rubber component may be used alone or in combinations of two or more. In view of the physical properties of tires, SBR, BR, and isoprene-based rubbers are preferred among these, with SBR and BR being more preferred.

Non-limiting examples of the SBR include emulsion-polymerized styrene-butadiene rubber (E-SBR) and solution-polymerized styrene-butadiene rubber (S-SBR). These may be used alone or in combinations of two or more.

The styrene content (amount of styrene) of the SBR is preferably 5% by mass or higher, more preferably 10% by mass or higher, still more preferably 15% by mass or higher, further preferably 23% by mass or higher. The styrene content is preferably 60% by mass or lower, more preferably 40% by mass or lower, still more preferably 30% by mass or lower. When the styrene content is within the range indicated above, the advantageous effect tends to be better achieved.

Herein, the styrene content of SBR is calculated by ¹H-NMR analysis.

When one type of SBR is used, the styrene content of the SBR refers to the styrene content of the one SBR. When multiple types of SBR are used, it refers to the average styrene content.

The average styrene content of the SBR can be calculated using the equation: {Σ(amount of each SBR×styrene content of the each SBR)}/amount of total SBR. For example, when 100% by mass of the rubber component includes 85% by mass of a SBR having a styrene content of 40% by mass and 5% by mass of a SBR having a styrene content of 25% by mass, the average styrene content of the SBR is 39.2% by mass (=(85×40±5×25)/(85+5)).

The vinyl content (amount of vinyl) of the SBR is preferably 5% by mass or higher, more preferably 10% by mass or higher, still more preferably 15% by mass or higher. The vinyl content is preferably 75% by mass or lower, more preferably 70% by mass or lower. When the vinyl content is within the range indicated above, the advantageous effect tends to be better achieved.

The vinyl content (1,2-bonded butadiene units) can be measured by infrared absorption spectrometry.

The vinyl content of the SBR refers to the ratio (unit: % by mass) of vinyl bonds (1,2-bonded butadiene units) based on the total mass of the butadiene moieties in the SBR taken as 100. The sum of the vinyl content (% by mass), the cis content (% by mass), and the trans content (% by mass) equals 100 (% by mass). When one type of SBR is used, the vinyl content of the SBR refers to the vinyl content of the one SBR. When multiple types of SBR are used, it refers to the average vinyl content.

The average vinyl content of the SBR can be calculated using the equation: Σ{amount of each SBR×(100 (% by mass)−styrene content (% by mass) of the each SBR)×vinyl content (% by mass) of the each SBR}/Σ{amount of each SBR×(100 (% by mass)−styrene content (% by mass) of the each SBR)}. For example, when 100 parts by mass of the rubber component includes 75 parts by mass of a SBR having a styrene content of 40% by mass and a vinyl content of 30% by mass, 15 parts by mass of a SBR having a styrene content of 25% by mass and a vinyl content of 20% by mass, and the remaining 10 parts by mass of a rubber component other than SBR, the average vinyl content of the SBR is 28% by mass (=(75×(100 (% by mass)−40 (% by mass))×30 (% by mass)+15×(100 (% by mass)−25 (% by mass))×20 (% by mass)}/{75×(100 (% by mass)−40 (% by mass))+15×(100 (% by mass)−25 (% by mass))}.

SBR products manufactured or sold by Sumitomo Chemical Co., Ltd., JSR Corporation, Asahi Kasei Corporation, Zeon Corporation, etc., may be used as the SBR.

When the rubber composition contains, as the modified rubber, a modified SBR containing the ionic functional group 1 that is at least one selected from the group consisting of carboxylic acid, sulfonic acid, and salts thereof in its molecule, the amount of the modified SBR based on 100% by mass of the rubber component is preferably 5% by mass or more, more preferably 20% by mass or more, still more preferably 40% by mass or more, particularly preferably 50% by mass or more. The upper limit is not limited, and it is preferably 90% by mass or less, more preferably 85% by mass or less, still more preferably 80% by mass or less, particularly preferably 75% by mass or less. When the amount is within the range indicated above, the advantageous effect can be suitably achieved.

Any BR may be used, such as high-cis BR having a high cis content, BR containing syndiotactic polybutadiene crystals, or BR synthesized using rare earth catalysts (rare earth-catalyzed BR). These may be used alone or in combination of two or more. High-cis BR having a cis content of 90% by mass or higher is preferred to improve abrasion resistance.

When the rubber composition contains, as the modified rubber, a modified BR containing the ionic functional group 1 that is at least one selected from the group consisting of carboxylic acid, sulfonic acid, and salts thereof in its molecule, the amount of the modified BR based on 100% by mass of the rubber component is preferably 5% by mass or more, more preferably 10% by mass or more, still more preferably 15% by mass or more, further preferably 20% by mass or more, further preferably 40% by mass or more, particularly preferably 50% by mass or more. The upper limit is not limited, and it is preferably 90% by mass or less, more preferably 85% by mass or less, still more preferably 80% by mass or less, particularly preferably 75% by mass or less. When the amount is within the range indicated above, the advantageous effect can be suitably achieved.

Examples of isoprene-based rubbers include natural rubber (NR), polyisoprene rubber (IR), refined NR, modified NR, and modified IR. Examples of NR include those commonly used in the rubber industry such as SIR20, RSS #3, and TSR20. Any IR may be used, including those commonly used in the rubber industry such as IR2200. Examples of refined NR include deproteinized natural rubbers (DPNR) and highly purified natural rubbers (UPNR). Examples of modified NR include epoxidized natural rubbers (ENR), hydrogenated natural rubbers (HNR), and grafted natural rubbers. Examples of modified IR include epoxidized polyisoprene rubbers, hydrogenated polyisoprene rubbers, and grafted polyisoprene rubbers. These may be used alone or in combinations of two or more.

When the rubber composition contains, as the modified rubber, a modified isoprene-based rubber containing the ionic functional group 1 that is at least one selected from the group consisting of carboxylic acid, sulfonic acid, and salts thereof in its molecule, the amount of the modified isoprene-based rubber based on 100% by mass of the rubber component is preferably 5% by mass or more, more preferably 10% by mass or more, still more preferably 15% by mass or more, particularly preferably 20% by mass or more. The upper limit is not limited, and it is preferably 80% by mass or less, more preferably 50% by mass or less, still more preferably 40% by mass or less, particularly preferably 35% by mass or less. When the amount is within the range indicated above, the advantageous effect can be suitably achieved.

In a suitable embodiment of the present disclosure, the modified rubber may specifically be, for example an emulsion polymerized styrene-butadiene rubber containing methacrylic acid in its molecule.

The rubber composition may contain a different rubber component other than the modified rubber. The different rubber usable in the rubber composition is preferably at least one selected from the group consisting of SBR, BR, and isoprene-based rubbers. The SBR, the BR, and the isoprene-based rubbers each may be a modified rubber other than the modified rubber or an unmodified rubber. Unmodified SBR, unmodified BR, and unmodified isoprene-based rubbers are preferred, and unmodified BR and unmodified isoprene-based rubbers are more preferred.

When the rubber composition contains a different rubber component other than the modified rubber, the amount of the different rubber component based on 100% by mass of the rubber component is preferably 5% by mass or more, more preferably 10% by mass or more, still more preferably 15% by mass or more, particularly preferably 20% by mass or more. The upper limit is not limited, and it is preferably 80% by mass or less, more preferably 70% by mass or less, still more preferably 50% by mass or less, further preferably 40% by mass or less, particularly preferably 35% by mass or less. When the amount is within the range indicated above, the advantageous effect can be suitably achieved. When unmodified SBR, unmodified isoprene-based rubbers, or unmodified BR is used as the different rubber, the amount of the unmodified SBR, the amount of the unmodified isoprene-based rubbers, or the amount of the unmodified BR is suitably within the range indicated above.

### (Alkali Metal Salt or Alkaline Earth Metal Salt)

The rubber composition preferably contains at least one alkali metal salt or alkaline earth metal salt selected from the group consisting of lithium carbonate, sodium carbonate, potassium carbonate, rubidium carbonate, cesium carbonate, beryllium carbonate, magnesium carbonate, calcium carbonate, strontium carbonate, barium carbonate, lithium acetate, sodium acetate, potassium acetate, rubidium acetate, cesium acetate, beryllium acetate, magnesium acetate, calcium acetate, strontium acetate, barium acetate, lithium phenoxide, sodium phenoxide, potassium phenoxide, rubidium phenoxide, cesium phenoxide, beryllium diphenoxide, magnesium diphenoxide, calcium diphenoxide, strontium diphenoxide, and barium diphenoxide. The alkali metal salt or alkaline earth metal salt may be used alone or in combinations of two or more.

In order to more suitably achieve the advantageous effect, the rubber composition more preferably contains at least one selected from the group consisting of potassium acetate, calcium acetate, sodium acetate, and magnesium acetate, still more preferably contains at least one selected from the group consisting of potassium acetate, calcium acetate, and sodium acetate, and particularly preferably contains at least one of potassium acetate or calcium acetate.

The reason why the above-described advantageous effect can be better achieved when these alkali metal salts or alkaline earth metal salts are used is not completely clear, but it is probably due to the following mechanism.

In the combination of the modified rubber containing a carboxylic acid or the like in its molecule and the specific alkali metal salt or alkaline earth metal salt, ionic bonds are formed between the carboxylic acid or the like and the metal of the alkali metal salt or alkaline earth metal salt. Thus, responsiveness to water is exhibited. In particular, the specific alkali metal salt or alkaline earth metal salt may provide high reinforcement and high responsiveness to water. Since the specific alkali metal salt or alkaline earth metal salt is easily dissociated with water, the responsiveness to water may be further improved. Thus, presumably, both a higher wet grip performance and a higher dry grip performance can be achieved in the case of the rubber composition containing the specific alkali metal salt or alkaline earth metal salt.

The amount of the alkali metal salt or alkaline earth metal salt (total amount of the alkali metal salt and alkaline earth metal salt) per 100 parts by mass of the rubber component in the rubber composition is preferably 0.5 parts by mass or more, more preferably 1.0 parts by mass or more, still more preferably 2.0 parts by mass or more, further preferably 2.2 parts by mass or more, further preferably 5.0 parts by mass or more, further preferably 7.24 parts by mass or more, while it is preferably 20.0 parts by mass or less, more preferably 17.0 parts by mass or less, still more preferably 12.0 parts by mass or less, further preferably 11.66 parts by mass or less, further preferably 10.0 parts by mass or less, further preferably 9.65 parts by mass or less. When the amount is within the range indicated above, the advantageous effect tends to be better achieved.

The apparent specific gravity of the alkali metal salt or alkaline earth metal salt is preferably less than 0.4 g/ml, more preferably 0.3 g/ml or less, still more preferably 0.25 g/ml or less, while it is preferably 0.05 g/ml or more, more preferably 0.15 g/ml or more. When the apparent specific gravity is within the range indicated above, the advantageous effect tends to be better achieved.

Here, the apparent specific gravity of the alkali metal salt or alkaline earth metal salt is determined by weighing 30 ml by apparent volume of the alkali metal salt or alkaline earth metal salt into a 50-ml measuring cylinder and calculating the apparent specific gravity from the mass.

The d50 of the alkali metal salt or alkaline earth metal salt is preferably less than 10 μm, more preferably 4.5 μm or less, still more preferably 1.5 μm or less, particularly preferably less than 0.75 μm, while it is preferably 0.05 μm or more, more preferably 0.45 μm or more. When the d50 is within the range indicated above, the advantageous effect tends to be better achieved.

Here, the d50 of the alkali metal salt or alkaline earth metal salt refers to a particle size corresponding to the 50th percentile of a mass-based particle size distribution curve obtained by a laser diffraction method.

The nitrogen adsorption specific surface area (N₂SA) of the alkali metal salt or alkaline earth metal salt is preferably 100 m/g or more, more preferably 115 m²/g or more, while it is preferably 250 m²/g or less, more preferably 225 m²/g or less, still more preferably 200 m²/g or less. When the N₂SA is within the range indicated above, the advantageous effect tends to be better achieved.

Here, the N₂SA of the alkali metal salt or alkaline earth metal salt is measured by the BET method in accordance with JIS Z 8830:2013.

Usable commercial products of the alkali metal salt or alkaline earth metal salt are available from Kyowa Chemical Industry, FUJIFILM Wako Pure Chemical Corporation, KISHIDA CHEMICAL Co., Ltd., Kyowa Chemical Industry, Tateho Chemical Industries Co., Ltd., JHE Co., Ltd, Nippon Chemical Industrial Co., Ltd, Ako Kasei Co., Ltd., etc.

### (Filler)

The rubber composition desirably contains filler. Examples of the filler include materials known in the rubber field, including inorganic fillers such as silica, carbon black, calcium carbonate, talc, alumina, clay, aluminum hydroxide, aluminum oxide, and mica; and hard-to-disperse fillers. Silica and carbon black are preferred among these.

Non-limiting examples of silica include dry silica (anhydrous silica) and wet silica (hydrous silica). Wet silica is preferred among these because it contains a large number of silanol groups.

The nitrogen adsorption specific surface area (N-SA) of the silica is preferably 30 m²/g or more, more preferably 100 m²/g or more, still more preferably 125 m²/g or more. The N₂SA of the silica is preferably 300 m²/g or less, more preferably 250 m²/g or less, still more preferably 200 m²/g or less, further preferably 175 m²/g or less. When the N₂SA is within the range indicated above, the advantageous effect can be suitably achieved.

Here, the N₂SA of silica is measured by the BET method in accordance with ASTM D3037-93.

Usable commercial products of silica are available from Evonik Degussa, Rhodia, Tosoh Silica Corporation, Solvay Japan, Tokuyama Corporation, etc.

The amount of silica per 100 parts by mass of the rubber component in the rubber composition is preferably 20 parts by mass or more, more preferably 40 parts by mass or more, still more preferably 45 parts by mass or more, further preferably 50 parts by mass or more, further preferably 65 parts by mass or more, further preferably 75 parts by mass or more. The upper limit of the amount is not limited, and it is preferably 150 parts by mass or less, more preferably 100 parts by mass or less, still more preferably 90 parts by mass or less. When the amount is within the range indicated above, the advantageous effect can be suitably achieved.

When the rubber composition contains silica, preferably it further contains a silane coupling agent. Non-limiting examples of silane coupling agents include silane coupling agents conventionally used with silica in the rubber industry, including: sulfide silane coupling agents such as bis(3-triethoxysilylpropyl)tetrasulfide, bis(2-triethoxysilylethyl)tetrasulfide, bis(4-triethoxysilylbutyl)tetrasulfide, bis(3-trimethoxysilylpropyl)tetrasulfide, bis(2-trimethoxysilylethyl)tetrasulfide, bis(2-triethoxysilylethyl)trisulfide, bis(4-trimethoxysilylbutyl)trisulfide, bis(3-triethoxysilylpropyl)disulfide, bis(2-triethoxysilylethyl)disulfide, bis(4-triethoxysilylbutyl)disulfide, bis(3-trimethoxysilylpropyl)disulfide, bis(2-trimethoxysilylethyl)disulfide, bis(4-trimethoxysilylbutyl)disulfide, 3-trimethoxysilylpropyl-N,N-dimethylthiocarbamoyl tetrasulfide, 2-triethoxysilylethyl-N,N-dimethylthiocarbamoyl tetrasulfide, and 3-triethoxysilylpropyl methacrylate monosulfide; mercapto silane coupling agents such as 3-mercaptopropyltrimethoxysilane, and 2-mercaptoethyltriethoxysilane; vinyl silane coupling agents such as vinyltriethoxysilane and vinyltrimethoxysilane; amino silane coupling agents such as 3-aminopropyltriethoxysilane and 3-aminopropyltrimethoxysilane; glycidoxy silane coupling agents such as γ-glycidoxypropyltriethoxysilane and γ-glycidoxypropyltrimethoxysilane; nitro silane coupling agents such as 3-nitropropyltrimethoxysilane and 3-nitropropyltriethoxysilane; and chloro silane coupling agents such as 3-chloropropyltrimethoxysilane and 3-chloropropyltriethoxysilane. Usable commercial products may be available from Evonik Degussa, Momentive, Shin-Etsu Silicone, Tokyo Chemical Industry Co., Ltd., AZmax. Co., Dow Corning Toray Co., Ltd., etc. These may be used alone or in combination of two or more.

The amount of silane coupling agents per 100 parts by mass of silica in the rubber composition is preferably 1.0 parts by mass or more, more preferably 5.0 parts by mass or more, still more preferably 8.0 parts by mass or more. The amount is preferably 20.0 parts by mass or less, more preferably 15.0 parts by mass or less, still more preferably 10.0 parts by mass or less. When the amount is within the range indicated above, the advantageous effect can be suitably achieved.

Examples of usable carbon black include N134, N110, N220, N234, N219, N339, N330, N326, N351, N550, and N762. These may be used alone or in combination of two or more. Usable commercial products may be available from Asahi Carbon Co., Ltd., Cabot Japan K.K., Tokai Carbon Co., Ltd., Mitsubishi Chemical Corporation, Lion Corporation, NSCC Carbon Co., Ltd., Columbia Carbon, etc.

The nitrogen adsorption specific surface area (N₂SA) of the carbon black is preferably 50 m²/g or more, more preferably 80 m²/g or more, still more preferably 100 m²/g or more, further preferably 114 m²/g or more. The N₂SA is preferably 200 m²/g or less, more preferably 150 m/g or less, still more preferably 130 m²/g or less. When the N₂SA is within the range indicated above, the advantageous effect tends to be better achieved.

Here, the N₂SA of carbon black can be determined in accordance with JIS K 6217-2:2001.

The amount of carbon black per 100 parts by mass of the rubber component in the rubber composition is preferably 1 part by mass or more, more preferably 3 parts by mass or more, still more preferably 5 parts by mass or more. The upper limit is preferably 30 parts by mass or less, more preferably 20 parts by mass or less, still more preferably 10 parts by mass or less. When the amount is within the range indicated above, the advantageous effect tends to be better achieved.

### (Plasticizer)

The rubber composition preferably contains a plasticizer. The term “plasticizer” refers to a material that can impart plasticity to rubber components. Examples include liquid plasticizers (plasticizers which are liquid at room temperature (25° C.)) and resins (resins which are solid at room temperature (25° C.)).

The amount of the plasticizer (total amount of plasticizers) per 100 parts by mass of the rubber component in the rubber composition is preferably 5 parts by mass or more, more preferably 20 parts by mass or more, still more preferably 25 parts by mass or more, particularly preferably 30 parts by mass or more. The upper limit is preferably 120 parts by mass or less, more preferably 100 parts by mass or less, still more preferably 90 parts by mass or less. When the amount is within the range indicated above, the advantageous effect tends to be better achieved.

Liquid plasticizers (plasticizers which are liquid at room temperature (25° C.)) usable in the rubber composition are not limited, and examples include oils and liquid polymers such as liquid resins, liquid diene-based polymers, and liquid farnesene-based polymers. These may be used alone or in combinations of two or more.

The amount of liquid plasticizers per 100 parts by mass of the rubber component in the rubber composition is preferably 3 parts by mass or more, more preferably 5 parts by mass or more, still more preferably 8 parts by mass or more, particularly preferably 10 parts by mass or more. The upper limit is preferably 50 parts by mass or less, more preferably 30 parts by mass or less, still more preferably 20 parts by mass or less. When the amount is within the range indicated above, the advantageous effect tends to be better achieved. The amount of liquid plasticizers includes the amount of oils in oil-extended rubbers. The amount of oils is suitably within the range indicated above.

Examples of the oils include process oils, plant oils, and mixtures thereof. Examples of the process oils include paraffinic process oils, aromatic process oils, and naphthenic process oils. Examples of the plant oils include castor oil, cotton seed oil, linseed oil, rapeseed oil, soybean oil, palm oil, coconut oil, peanut oil, rosin, pine oil, pine tar, tall oil, corn oil, rice oil, safflower oil, sesame oil, olive oil, sunflower oil, palm kernel oil, camellia oil, jojoba oil, macadamia nut oil, and tung oil. Usable commercial products may be available from Idemitsu Kosan Co., Ltd., Sankyo Yuka Kogyo K. K., ENEOS Corporation, Olisoy, H&R, Hokoku Corporation, Showa Shell Sekiyu K. K., Fuji Kosan Co., Ltd., The Nisshin Oillio Group, etc. Process oils such as paraffinic process oils, aromatic process oils, and naphthenic process oils, and plant oils are preferred among these.

Examples of the liquid resins include terpene resins (including terpene phenolic resins and aromatic modified terpene resins), rosin resins, styrene resins, C5 resins, C9 resins, C5/C9 resins, dicyclopentadiene (DCPD) resins, coumarone-indene resins (including resins based on coumarone or indene alone), phenolic resins, olefin resins, polyurethane resins, and acrylic resins. Hydrogenated products of these resins are also usable.

Examples of the liquid diene-based polymers include liquid styrene-butadiene copolymers (liquid SBR), liquid polybutadiene polymers (liquid BR), liquid polyisoprene polymers (liquid IR), liquid styrene-isoprene copolymers (liquid SIR), liquid styrene-butadiene-styrene block copolymers (liquid SBS block polymers), and liquid styrene-isoprene-styrene block copolymers (liquid SIS block polymers), all of which are liquid at 25° C. The chain ends or backbones of these polymers may be modified with a polar group. Hydrogenated products of these polymers are also usable.

In the rubber composition, the reversible change with water in E* or in tan δ represented by at least one of the formula (1-1) or the formula (1-2) can also be achieved by using a combination of a modified liquid diene-based polymer containing at least one selected from the group consisting of carboxylic acid, sulfonic acid, and salts thereof in its molecule and the alkali metal salt or alkaline earth metal salt, instead of the combination of the modified rubber and the alkali metal salt or alkaline earth metal salt. The combination of the modified liquid diene-based polymer and the alkali metal salt or alkaline earth metal salt can also provide the same advantageous effect due to the mechanism in the case of the combination of the modified rubber and the alkali metal salt or alkaline earth metal salt.

The modification of the modified liquid diene-based polymer is as described for the modification of the modified rubber.

The modified liquid diene-based polymer contains at least one ionic functional group selected from the group consisting of carboxylic acid, sulfonic acid, and salts thereof in its molecule. The number of the functional group per molecule is preferably 1 to 100, more preferably 2 to 50, still more preferably 5 to 25, further preferably 10 to 20.

The number of the functional group per molecule can be determined by performing infrared absorption spectrometry and calculating the number based on the peak corresponding to the functional group.

The number average molecular weight of the modified liquid diene-based polymer is preferably 1000 to 50000, more preferably 1500 to 40000, still more preferably 2000 to 35000, further preferably 3000 to 30000.

Here, the number average molecular weight can be determined by gel permeation chromatography (GPC) using a calibration curve based on standard polystyrene.

When the modified liquid diene-based polymer is used, the rubber composition may not contain the modified rubber as a rubber component and contains a different rubber component other than the modified rubber instead as well as a combination of the modified liquid diene-based polymer and the alkali metal salt or alkaline earth metal salt. Alternatively, the rubber composition may contain the modified rubber as a rubber component and also contains a combination of the modified liquid diene-based polymer and the alkali metal salt or alkaline earth metal salt.

In order to suitably achieve the advantageous effect, the modified liquid diene-based polymer is preferably a modified liquid IR containing at least one selected from the group consisting of carboxylic acid, sulfonic acid, and salts thereof in its molecule, more preferably a liquid IR containing methacrylic acid or maleic acid in its molecule.

The amount of the modified liquid diene-based polymer, if present, in the rubber composition per 100 parts by mass of the rubber component is preferably 5 parts by mass or more, more preferably 10 parts by mass or more, still more preferably 15 parts by mass or more, particularly preferably 20 parts by mass or more. The amount is preferably 50 parts by mass or less, more preferably 40 parts by mass or less, still more preferably 35 parts by mass or less, particularly preferably 30 parts by mass or less. When the amount is within the range indicated above, the advantageous effect can be suitably achieved.

Examples of the liquid farnesene-based polymers include liquid farnesene polymers and liquid farnesene-butadiene copolymers, all of which are liquid at 25° C. The chain ends or backbones of these may be modified with a polar group. Hydrogenated products of these are also usable.

Examples of the resin (resin which is solid at room temperature (25° C.)) usable in the rubber composition include aromatic vinyl polymers, coumarone-indene resin, coumarone resin, indene resin, phenol resin, rosin resin, petroleum resin, terpene-based resins, and acrylic resins, all of which are solid at room temperature (25° C.). The resin may be hydrogenated. These may be used alone or in combinations of two or more. Aromatic vinyl polymers, petroleum resins, and terpene-based resins are preferred among these.

The amount of the resin per 100 parts by mass of the rubber component in the rubber composition is preferably 5 parts by mass or more, more preferably 10 parts by mass or more, still more preferably 15 parts by mass or more, particularly preferably 20 parts by mass or more. The upper limit is preferably 60 parts by mass or less, more preferably 40 parts by mass or less, still more preferably 30 parts by mass or less. When the amount is within the range indicated above, the advantageous effect tends to be better achieved.

The softening point of the resin is preferably 50° C. or higher, more preferably 55° C. or higher, still more preferably 60° C. or higher, further preferably 85° C. or higher. The upper limit is preferably 160° C. or lower, more preferably 150° C. or lower, still more preferably 145° C. or lower. When the softening point is within the range indicated above, the advantageous effect tends to be better achieved. Here, the softening point of the resin is measured in accordance with JIS K 6220-1:2001 using a ring and ball softening point measuring apparatus, and the temperature at which the ball drops down is defined as the softening temperature.

The aromatic vinyl polymers refer to polymers containing aromatic vinyl monomers as structural units. Examples include resins produced by polymerizing α-methylstyrene and/or styrene. Specific examples include styrene homopolymers (styrene resins), α-methylstyrene homopolymers (α-methylstyrene resins), copolymers of α-methylstyrene and styrene, and copolymers of styrene and other monomers.

The coumarone-indene resins refer to resins containing coumarone and indene as the main monomer components forming the skeleton (backbone) of the resins. Examples of monomer components which may be contained in the skeleton in addition to coumarone and indene include styrene, α-methylstyrene, methylindene, and vinyltoluene.

The coumarone resins refer to resins containing coumarone as the main monomer component forming the skeleton (backbone) of the resins.

The indene resins refer to resins containing indene as the main monomer component forming the skeleton (backbone) of the resins.

Examples of the phenol resins include known polymers produced by reacting phenol with an aldehyde such as formaldehyde, acetaldehyde, or furfural in the presence of an acid or alkali catalyst. Preferred among these are those produced by the reaction in the presence of an acid catalyst, such as novolac phenol resins.

Examples of the rosin resins include rosin resins typified by natural rosins, polymerized rosins, modified rosins, and esterified compounds thereof, and hydrogenated products thereof.

Examples of the petroleum resins include C5 resins, C9 resins, C5/C9 resins, dicyclopentadiene (DCPD) resins, and hydrogenated products of these resins. DCPD resins and hydrogenated DCPD resins are preferred among these.

The terpene resins refer to polymers containing terpene as a structural unit. Examples include polyterpene resins produced by polymerizing terpene compounds, and aromatic modified terpene resins produced by polymerizing terpene compounds and aromatic compounds. Examples of usable aromatic modified terpene resins include terpene-phenol resins made from terpene compounds and phenolic compounds, terpene-styrene resins made from terpene compounds and styrene compounds, and terpene-phenol-styrene resins made from terpene compounds, phenolic compounds, and styrene compounds. Examples of terpene compounds include α-pinene and μ-pinene. Examples of phenolic compounds include phenol and bisphenol A. Examples of aromatic compounds include styrene compounds such as styrene and α-methylstyrene.

The acrylic resins refer to polymers containing acrylic monomers as structural units. Examples include styrene acrylic-based resins, such as styrene acrylic resins, which contain carboxy groups and are produced by copolymerizing aromatic vinyl monomer components and acrylic monomer components. Solvent-free, carboxy group-containing styrene acrylic-based resins are suitably usable among these.

Examples of usable commercial plasticizers include products available from Maruzen Petrochemical Co., Ltd., Sumitomo Bakelite Co., Ltd., Yasuhara Chemical Co., Ltd., TOSOH Corporation, Rutgers Chemicals, BASF, Arizona Chemical, Nitto Chemical Co., Ltd., Nippon Shokubai Co., Ltd., ENEOS Corporation, Arakawa Chemical Industries, Ltd., Taoka Chemical Co., Ltd., etc.

### (Other Components)

From the standpoint of properties such as cracking resistance and ozone resistance, the rubber composition preferably contains an antioxidant.

Non-limiting examples of the antioxidant include naphthylamine antioxidants such as phenyl-α-naphthylamine; diphenylamine antioxidants such as octylated diphenylamine and 4, 4′-bis (α, α′-dimethylbenzyl) diphenylamine; p-phenylenediamine antioxidants such as N-isopropyl-N′-phenyl-p-phenylenediamine, N-(1,3-dimethylbutyl)-N′-phenyl-p-phenylenediamine, and N,N′-di-2-naphthyl-p-phenylenediamine; quinoline antioxidants such as polymerized 2,2,4-trimethyl-1,2-dihydroquinoline; monophenolic antioxidants such as 2,6-di-t-butyl-4-methylphenol and styrenated phenol; and bis-, tris-, or polyphenolic antioxidants such as tetrakis[methylene-3-(3′,5′-di-t-butyl-4′-hydroxyphenyl)propionate]methane. Preferred among these are p-phenylenediamine antioxidants and quinoline antioxidants, and more preferred are N-(1,3-dimethylbutyl)-N′-phenyl-p-phenylenediamine and polymerized 2,2,4-trimethyl-1,2-dihydroquinoline. Usable commercial products may be available from Seiko Chemical Co., Ltd., Sumitomo Chemical Co., Ltd., Ouchi Shinko Chemical Industrial Co., Ltd., Flexsys, etc.

The amount of antioxidants per 100 parts by mass of the rubber component in the rubber composition is preferably 0.2 parts by mass or more, more preferably 0.5 parts by mass or more. The amount is preferably 7.0 parts by mass or less, more preferably 4.0 parts by mass or less, still more preferably 2.8 parts by mass or less.

The rubber composition may contain stearic acid. The amount of stearic acid per 100 parts by mass of the rubber component in the rubber composition is preferably 0.5 to 10 parts by mass, more preferably 0.5 to 5 parts by mass, still more preferably 0.5 to 2 parts by mass.

The stearic acid may be conventional one. Usable commercial products may be available from NOF Corporation, Kao Corporation, FUJIFILM Wako Pure Chemical Corporation, Chiba Fatty Acid Co., Ltd., etc.

The rubber composition may contain zinc oxide.

The amount of zinc oxide per 100 parts by mass of the rubber component in the rubber composition is preferably 0.5 to 10 parts by mass, more preferably 1 to 5 parts by mass.

The zinc oxide may be conventional one. Usable commercial products may be available from Mitsui Mining & Smelting Co., Ltd., Toho Zinc Co., Ltd., HakusuiTech Co., Ltd., Seido Chemical Industry Co., Ltd., Sakai Chemical Industry Co., Ltd., etc.

The rubber composition may contain wax. The amount of wax per 100 parts by mass of the rubber component in the rubber composition is preferably 0.5 to 10 parts by mass, more preferably 1 to 5 parts by mass.

Non-limiting examples of the wax include petroleum waxes and natural waxes and also include synthetic waxes prepared by purifying or chemically treating a plurality of waxes. Each of these waxes may be used alone or in combination of two or more.

Examples of the petroleum waxes include paraffin waxes and microcrystalline waxes. The natural waxes may be any wax derived from non-petroleum resources, and examples include plant waxes such as candelilla wax, carnauba wax, Japan wax, rice wax, and jojoba wax; animal waxes such as beeswax, lanolin, and spermaceti; mineral waxes such as ozokerite, ceresin, and petrolatum; and purified products of these waxes. Usable commercial products may be available from Ouchi Shinko Chemical Industrial Co., Ltd., Nippon Seiro Co., Ltd., Seiko Chemical Co., Ltd., etc.

The rubber composition may contain sulfur to moderately form crosslinks between the polymer chains, thereby imparting good balance of the properties.

The amount of sulfur per 100 parts by mass of the rubber component in the rubber composition is preferably 0.1 parts by mass or more, more preferably 0.5 parts by mass or more, still more preferably 0.7 parts by mass or more, further preferably 1.0 parts by mass or more. The amount is preferably 6.0 parts by mass or less, more preferably 4.0 parts by mass or less, still more preferably 3.0 parts by mass or less.

Examples of the sulfur include those commonly used in the rubber industry, such as powdered sulfur, precipitated sulfur, colloidal sulfur, insoluble sulfur, highly dispersible sulfur, and soluble sulfur. Usable commercial products may be available from Tsurumi Chemical Industry Co., Ltd., Karuizawa sulfur Co., Ltd., Shikoku Chemicals Corporation, Flexsys, Nippon Kanryu Industry Co., Ltd., Hosoi Chemical Industry Co., Ltd., etc. These may be used alone or in combination of two or more.

The rubber composition may contain a vulcanization accelerator.

The amount of vulcanization accelerators per 100 parts by mass of the rubber component in the rubber composition is usually 0.3 to 10 parts by mass, preferably 0.5 to 7 parts by mass.

Any type of vulcanization accelerator may be used, including usually used ones. Examples of vulcanization accelerators include thiazole vulcanization accelerators such as 2-mercaptobenzothiazole, di-2-benzothiazolyl disulfide, and N-cyclohexyl-2-benzothiazylsulfenamide; thiuram vulcanization accelerators such as tetramethylthiuram disulfide (TMTD), tetrabenzylthiuram disulfide (TBzTD), and tetrakis(2-ethylhexyl)thiuram disulfide (TOT-N); sulfenamide vulcanization accelerators such as N-cyclohexyl-2-benzothiazole sulfenamide, N-t-butyl-2-benzothiazolylsulfenamide, N-oxyethylene-2-benzothiazole sulfenamide, and N,N′-diisopropyl-2-benzothiazole sulfenamide; and guanidine vulcanization accelerators such as diphenylguanidine, diorthotolylguanidine, and orthotolylbiguanidine. These may be used alone or in combination of two or more. Sulfenamide vulcanization accelerators and guanidine vulcanization accelerators are preferred among these.

Sulfenamide vulcanization accelerators and guanidine vulcanization accelerators are preferred among the vulcanization accelerators. Although the amount of sulfenamide vulcanization accelerators is not limited, the amount per 100 parts by mass of the rubber component is preferably 0.3 to 4.0 parts by mass, preferably 0.5 to 2.5 parts by mass, still more preferably 0.7 to 1.6 parts by mass. Although the amount of guanidine vulcanization accelerators is not limited, the amount per 100 parts by mass of the rubber component is preferably 0.5 to 5.0 parts by mass, preferably 0.8 to 3.0 parts by mass, still more preferably 1.0 to 2.3 parts by mass.

The rubber composition may contain other appropriate additives usually used in the application field, such as a release agent or a pigment, in addition to the above-described components.

The rubber composition may be prepared by known methods. For example, it may be prepared by kneading the components in a rubber kneading machine such as an open roll mill or a Banbury mixer, optionally followed by crosslinking. The kneading conditions include a kneading temperature of usually 50° C. to 200° C., preferably 80° C. to 190° C., and a kneading time of usually 30 seconds to 30 minutes, preferably 1 minute to 30 minutes.

The tire of the present disclosure includes a tread with at least one circumferential groove. The circumferential groove is formed of the groove-forming rubber composition.

The present disclosure is described in detail below based on, but not limited to, an exemplary preferred embodiment with appropriate reference to the drawings.

Herein, the dimensions of the components of the tire are measured for the tire in the normal state, unless otherwise stated.

Herein, the term “normal state” refers to a state where the tire is mounted on a normal rim (not shown), inflated to a normal internal pressure, and under no load.

If measurement of the tire mounted on a normal rim is impossible, the dimensions and angles of the components of the tire in a meridional cross-section of the tire are measured in a cross-section of the tire cut along a plane including the axis of rotation, in which the distance between the right and left beads corresponds to the distance between the beads in the tire mounted on a normal rim.

The term “normal rim” refers to a rim specified for each tire by the standard in a standard system including standards according to which the tire is provided, and may be, for example, “standard rim” with the applicable size listed in “JATMA YEAR BOOK” of The Japan Automobile Tyre Manufacturers Association, Inc. (JATMA), “measuring rim” listed in “Standards Manual” of The European Tyre and Rim Technical Organisation (ETRTO), or “design rim” listed in “YEAR BOOK” of The Tire and Rim Association, Inc. (TRA). Here, JATMA, ETRTO, and TRA will be referenced in that order, and if the referenced standard includes the applicable size, it will be followed. Moreover, for a tire which is not defined by any of the standards, it refers to a rim with the smallest diameter and, secondly, the narrowest width among the rims on which the tire can be mounted and can maintain the internal pressure, i.e., the rims that cause no air leakage between the rim and the tire.

The term “normal internal pressure” refers to an air pressure specified for each tire by the standard in a standard system including standards according to which the tire is provided, and may be “maximum air pressure” in JATMA, “inflation pressure” in ETRTO, or the maximum value shown in Table “TIRE LOAD LIMITS AT VARIOUS COLD INFLATION PRESSURES” in TRA. Like “normal rim”, JATMA, ETRTO, and TRA will be referenced in that order, and the corresponding standard will be followed. Moreover, for a tire which is not defined by any of the standards, it refers to a normal internal pressure of 250 kPa or more for another tire size defined by any of the standards, for which the normal rim is listed as the standard rim. Here, when a plurality of normal internal pressures of 250 kPa or more are listed, it refers to the smallest one of these normal internal pressures.

Herein, the term “normal load” refers to a load specified for each tire by the standard in a standard system including standards according to which the tire is provided. The normal load may be “maximum load capacity” in JATMA, “load capacity” in ETRTO, or the maximum value shown in Table “TIRE LOAD LIMITS AT VARIOUS COLD INFLATION PRESSURES” in TRA. Like “normal rim” and “normal internal pressure” described above, JATMA, ETRTO, and TRA will be referenced in that order, and the corresponding standard will be followed. Moreover, for a tire which is not defined by any of the standards, the normal load W_{L} is calculated by the following equations.

$$V = \{ {( Dt / 2 )}^{2} - {( Dt / 2 - Ht )}^{2} \} \times π \times Wt$$

$${W}_{L} = 0.000011 \times V + 175$$

W_{L}: normal load (kg)
V: virtual volume (mm³) of tire
Dt: outer diameter (mm) of tire
Ht: cross-sectional height (mm) of tire
Wt: cross-sectional width (mm) of tire

The “cross-sectional width Wt (mm)” of the tire refers to the largest width of the tire in the normal state between the outer surfaces of the sidewalls, excluding patterns, letters, and the like on the sides of the tire, if present.

The term “outer diameter Dt (mm)” of the tire refers to the outer diameter of the tire in the normal state.

The term “cross-sectional height Ht (mm)” of the tire refers to the height in the tire radial direction in a radial cross-section of the tire. Provided that the rim diameter of the tire is R (mm), the height corresponds to a half of the difference between the outer diameter Dt and the rim diameter R of the tire. In other words, the cross-sectional height Ht can be determined by (Dt−R)/2.

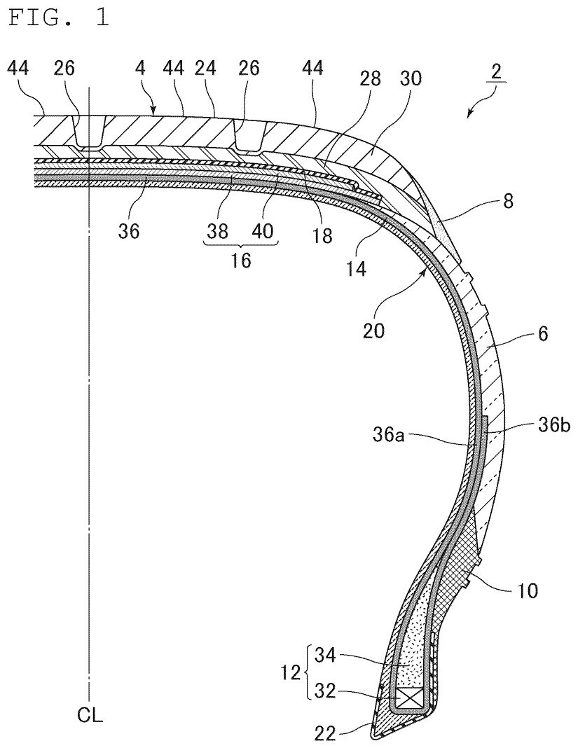

FIG. 1 shows a pneumatic tire 2. In FIG. 1, the vertical direction corresponds to the radial direction of the tire 2, the horizontal direction corresponds to the axial direction of the tire 2, and the direction perpendicular to the paper corresponds to the circumferential direction of the tire 2. In FIG. 1, the dash-dot-dash line CL represents the equator of the tire 2. The shape of the tire 2 is symmetrical to the equator, except for the tread pattern.

The tire 2 includes a tread 4, a pair of sidewalls 6, a pair of wings 8, a pair of clinches 10, a pair of beads 12, a carcass 14, a belt 16, a band 18, an innerliner 20, and a pair of chafers 22. The tire 2 is a tubeless tire. The tire 2 will be mounted on a passenger vehicle.

The tread 4 has a radially outwardly convex shape. The tread 4 defines a tread surface 24 that will contact the road surface. The tread 4 has circumferential grooves 26 engraved thereon. The circumferential grooves 26 are grooves extending in the tire circumferential direction. The circumferential grooves 26 are continuous in the circumferential direction and may be jig-zag, curved, or straight. The circumferential grooves 26 define a tread pattern. The tread 4 has a base layer 28 and a cap layer 30. The cap layer 30 is located radially outward of the base layer 28. The cap layer 30 is stacked on the base layer 28.

Although FIG. 1 shows an example of the tread 4 having a two-layer structure consisting of the cap layer 30 and the base layer 28, the tread 4 may be a monolayer tread or a three or more-layer tread.

In the present disclosure, at least one circumferential groove among rubber layers (layers of cross-linked rubber compositions) constituting the tread 4 is formed of the groove-forming rubber composition. Preferably, all the circumferential grooves are formed of the groove-forming rubber composition. More preferably, at least the outermost layer among rubber layers constituting the tread 4 is formed of the groove-forming rubber composition. Specifically, for a monolayer tread, the monolayer tread is desirably formed of the rubber composition; for a two-layer tread, a cap layer of the two-layer tread is desirably formed of the rubber composition; and for a three or more-layer tread, a cap layer (outermost surface layer) is desirably formed of the rubber composition.

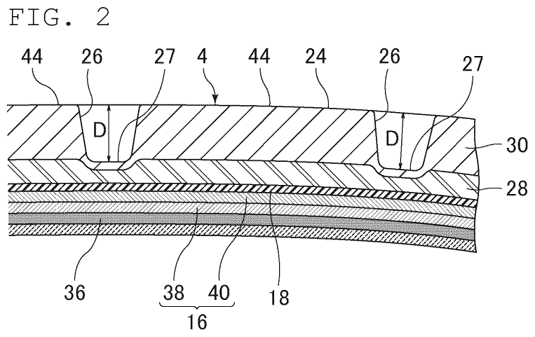

FIG. 2 shows an enlarged cross-sectional view of the tread 4 and its vicinity of the tire 2 in FIG. 1. In FIG. 2, the vertical direction corresponds to the radial direction of the tire 2, the horizontal direction corresponds to the axial direction of the tire 2, and the direction perpendicular to the paper corresponds to the circumferential direction of the tire 2.

In the tire 2 shown in the enlarged cross-sectional view of FIG. 2, the groove depth D (mm) of each circumferential groove 26 is preferably 13.0 mm or less, more preferably 12.0 mm or less, still more preferably 11.5 mm or less, further preferably 10.0 mm or less, while it is preferably 3.5 mm or more, more preferably 6.0 mm or more, still more preferably 8.0 mm or more. When the groove depth is within the range indicated above, the advantageous effect tends to be better achieved.

Herein, the term “groove depth of each circumferential groove 26” refers to a distance measured along the normal of a plane extended from a ground contact face defining the outermost surface of the tread. The groove depth is a distance from a plane extended from the plane defining the ground contact face to a deepest bottom. In FIG. 2, the groove depth of the circumferential groove 26 means the length of D.

In the tire 2 in FIG. 1, the groove depth D (mm) of the circumferential grooves 26 and the above-described value of “E* when wet with water/E* when dry” satisfy the following formula (2):

$$D / ( E * when wet with water / E * when dry ) > 9. \qquad ( 2 )$$

where E* represents a complex modulus of elasticity (MPa) after 30 minutes from the start of measurement under the conditions of a temperature of 30° C., an initial strain of 10%, a dynamic strain of 1%, a frequency of 10 Hz, an elongation mode, and a measurement duration of 30 minutes, and D represents the groove depth (mm) of the circumferential groove 26.

The value of “D/(E* when wet with water/E* when dry)” is preferably 9.2 or more, more preferably 9.3 or more, still more preferably 9.4 or more, further preferably 9.5 or more, further preferably 9.6 or more, further preferably 9.8 or more, further preferably 10.0 or more, further preferably 10.1 or more, more preferably 10.3 or more, further preferably 11.0 or more, further preferably 11.8 or more, further preferably 11.9 or more. The upper limit is not limited, and it is preferably 16.0 or less, more preferably 15.0 or less, still more preferably 14.0 or less, particularly preferably 13.0 or less. When the value is within the range indicated above, the advantageous effect can be suitably achieved.

In the tire 2 in FIG. 1, each sidewall 6 extends substantially inwardly in the radial direction from an end of the tread 4. The radially outer portion of the sidewall 6 is bonded to the tread 4. The radially inner portion of the sidewall 6 is bonded to the clinch 10.

Each wing 8 is located between the tread 4 and the sidewall 6. The wing 8 is bonded to both the tread 4 and the sidewall 6.

Each clinch 10 is located substantially radially inward of the sidewall 6. The clinch 10 is located axially outwardly from the bead 12 and the carcass 14.

Each bead 12 is located axially inward of the clinch 10. Each bead 12 includes a core 32 and an apex 34 that radially outwardly extends from the core 32. The core 32 has a ring shape and contains a wound non-stretchable wire, etc. The apex 34 is radially outwardly tapered.

The carcass 14 includes a carcass ply 36. Although the carcass 14 in the tire 2 includes one carcass ply 36, the carcass 14 may include two or more carcass plies 36.

In the tire 2, the carcass ply 36 extends between the beads 12 on opposite sides along the tread 4 and the sidewalls 6. The carcass ply 36 is folded around each core 32 from the inside to the outside in the axial direction. Due to this folding, the carcass ply 36 is provided with a main portion 36a and a pair of folded portions 36b. Namely, the carcass ply 36 includes the main portion 36a and the pair of folded portions 36b.

Although not shown, examples of the carcass ply 36 include carcass plies which include a large number of parallel cords and a topping rubber. The carcass 14 preferably has a radial structure.

A belt 16 is located radially inward of the tread 4. The belt 16 is stacked on the carcass 14. The belt 16 includes an interior layer 38 and an exterior layer 40.

Although not shown, examples of the interior layer 38 and the exterior layer 40 each include layers which include a large number of parallel cords and a topping rubber. Each cord is tilted relative to the equator, for example. The tilt direction of the cords in the interior layer 38 relative to the equator is opposite to the tilt direction of the cords in the exterior layer 40 relative to the equator.

A band 18 is located radially outward of the belt 16. The band 18 has a width that is equal to or nearly equal to the width of the belt 16 in the axial direction. The band 18 may be wider than the belt 16.

Although not shown, examples of the band 18 include bands which include cords and a topping rubber. The cords are spirally wound, for example.

The belt 16 and the band 18 form a reinforcement layer. The reinforcement layer may be formed only of the belt 16.

An innerliner 20 is located inward of the carcass 14. The innerliner 20 is bonded to the inner surface of the carcass 14.

Each chafer 22 is located near the bead 12. In this embodiment, examples of the chafer 22 include chafers which include a rubber and a fabric impregnated with the rubber. The chafer 22 may be integrated with the clinch 10.

As shown in FIG. 1, the tread 4 of the tire 2 has a plurality of, specifically three, circumferential grooves 26 engraved thereon. The circumferential grooves 26 are positioned at intervals in the axial direction. As the three circumferential grooves 26 are engraved on the tread 4, the tread 4 is provided with four ribs 44 extending in the circumferential direction. In other words, each circumferential groove 26 is between one rib 44 and another rib 44.

The circumferential grooves 26 extend in the circumferential direction. The circumferential grooves 26 are continuous in the circumferential direction without interruption.

In the production of the tire 2, a plurality of rubber-based tire components are assembled with one another into a raw cover (unvulcanized tire 2). The raw cover is introduced into a mold. The outer surface of the raw cover contacts a cavity surface of the mold. The inner surface of the raw cover contacts a bladder or a core. The raw cover is pressurized and heated in the mold, so that the polymer composition in the raw cover flows. The heating causes a rubber crosslinking reaction to give the tire 2. The tire 2 is provided with a projection and recess pattern by using a mold having the projection and recess pattern on the cavity surface.

Examples of the tire 2 include pneumatic tires and non-pneumatic tires. Of these, the tire is preferably a pneumatic tire. In particular, the tire can be suitably used as a summer tire or a winter tire (studless tire, snow tire, studded tire, etc.), for example. The tire can be used for passenger cars, large passenger cars, large SUVs, heavy-duty vehicles such as trucks and buses, light trucks, or motorcycles, or as a racing tire (high performance tire), etc.

### EXAMPLES

Examples (working examples) which are considered preferable to implement the present disclosure are described below. Yet, the scope of the disclosure is not limited to the examples.

The chemicals used in examples and comparative examples are collectively described below.
Carboxylic acid-modified SBR: synthesized by Production Example 1 described below (carboxylic acid group content: 5% by mass, styrene content: 23% by mass, butadiene content: 72% by mass)
Carboxylic acid-modified BR: synthesized by Production Example 2 described below (carboxylic acid group content: 5% by mass, butadiene content: 95% by mass)
NR: TSR20
SBR: Nipol 1502 (E-SBR) available from ZEON Corporation
BR: BR730 (high-cis polybutadiene, cis content: 96% by mass) available from JSR Corporation
Maleic acid-modified liquid IR: LIR-410 (number of functional groups per molecule: 10, number average molecular weight: 30000) available from Kuraray
Carbon black: DIABLACK I (N220, N₂SA: 114 m²/g, DBP: 114 ml/100 g) available from Mitsubishi Chemical Corporation
Silica: ULTRASIL VN3 (N₂SA: 175 m²/g) available from Evonik Degussa
Stearic acid: stearic acid “TSUBAKI” available from NOF Corporation
Potassium acetate: potassium acetate available from FUJIFILM Wako Pure Chemical Corporation
Calcium acetate: calcium acetate available from FUJIFILM Wako Pure Chemical Corporation
Zinc oxide: zinc oxide #1 available from Mitsui Mining & Smelting Co., Ltd.
Oil: VIVATEC 400/500 (TDAE oil) available from H&R
Silane coupling agent: Si69 (bis(3-triethoxysilylpropyl)tetrasulfide) available from EVONIK-DEGUSSA
Resin: SYLVARES SA85 (a copolymer of α-methylstyrene and styrene, Tg: 43° C., softening point: 85° C.) available from Arizona chemical
Antioxidant: Antigen 6C (antioxidant, N-(1,3-dimethylbutyl)-N′-phenyl-p-phenylenediamine) available from Sumitomo Chemical Co., Ltd.
Sulfur: powdered sulfur available from Tsurumi Chemical Industry Co., Ltd.
Vulcanization accelerator DPG: NOCCELER D (1,3-diphenyl guanidine) available from Ouchi Shinko Chemical Industrial Co., Ltd.
Vulcanization accelerator NS: NOCCELER NS (N-tert-butyl-2-benzothiazylsulfenamide) available from Ouchi Shinko Chemical Industrial Co., Ltd.

### Production Example 1: Synthesis of Carboxylic Acid-Modified SBR

### (Preparation of Latex)

An amount of 2000 g of distilled water, 45 g of emulsifier (1), 1.5 g of emulsifier (2), 8 g of an electrolyte, 250 g of styrene, 50 g of methacrylic acid, 700 g of polybutadiene, and 2 g of a molecular weight regulator are charged into a pressure-resistant reactor provided with a stirrer. The reactor temperature is set to 5° C. An aqueous solution containing 1 g of a radical initiator and 1.5 g of SFS dissolved therein and an aqueous solution containing 0.7 g of EDTA and 0.5 g of a catalyst dissolved therein are added to the reactor to initiate polymerization. Five hours after the initiation of polymerization, 2 g of a polymerization terminator is added to stop the reaction, whereby latex is prepared.

### (Preparation of Rubber)

Unreacted monomers are removed from the obtained latex by steam distillation. Then, the latex is added to alcohol and coagulated while the pH is adjusted to 3 to 5 with a saturated sodium chloride aqueous solution or formic acid to give a crumb polymer. The polymer is dried with a vacuum dryer at 40° C. to obtain a solid rubber (emulsion-polymerized rubber).

### Production Example 2: Synthesis of Carboxylic Acid-Modified BR

### (Preparation of Latex)

An amount of 2000 g of distilled water, 45 g of emulsifier (1), 1.5 g of emulsifier (2), 8 g of an electrolyte, 50 g of methacrylic acid, 950 g of polybutadiene, and 2 g of a molecular weight regulator are charged into a pressure-resistant reactor provided with a stirrer. The reactor temperature is set to 5° C. An aqueous solution containing 1 g of a radical initiator and 1.5 g of SFS dissolved therein and an aqueous solution containing 0.7 g of EDTA and 0.5 g of a catalyst dissolved therein are added to the reactor to initiate polymerization. Five hours after the initiation of polymerization, 2 g of a polymerization terminator is added to stop the reaction, whereby latex is prepared.

### (Preparation of Rubber)

Unreacted monomers are removed from the obtained latex by steam distillation. Then, the latex is added to alcohol and coagulated while the pH is adjusted to 3 to 5 with a saturated sodium chloride aqueous solution or formic acid to give a crumb polymer. The polymer is dried with a vacuum dryer at 40° C. to obtain a solid rubber (emulsion-polymerized rubber).

Materials used in Production Examples 1 and 2 are as follows.

Emulsifier (1): rosin acid soap available from Harima Chemicals Group, Inc.

Emulsifier (2): fatty acid soap available from FUJIFILM Wako Pure Chemical Corporation
Electrolyte: sodium phosphate available from FUJIFILM Wako Pure Chemical Corporation
Styrene: styrene available from FUJIFILM Wako Pure Chemical Corporation
Methacrylic acid: methacrylic acid available from FUJIFILM Wako Pure Chemical Corporation
Butadiene: 1,3-butadiene available from Takachiho Chemical Industrial Co., Ltd.
Molecular weight regulator: tert-dodecylmercaptan available from FUJIFILM Wako Pure Chemical Corporation
Radical initiator: paramenthane hydroperoxide available from NOF Corporation
SFS: sodium formaldehyde sulfoxylate available from FUJIFILM Wako Pure Chemical Corporation
EDTA: sodium ethylenediaminetetraacetate available from FUJIFILM Wako Pure Chemical Corporation
Catalyst: ferric sulfate available from FUJIFILM Wako Pure Chemical Corporation
Polymerization terminator: N,N′-dimethyldithiocarbamate available from FUJIFILM Wako Pure Chemical Corporation
Alcohol: methanol, ethanol available from Kanto Chemical Co., Inc.
Formic acid: formic acid available from Kanto Chemical Co., Inc.
Sodium chloride: sodium chloride available from FUJIFILM Wako Pure Chemical Corporation

### <Nmr Analysis>

The carboxylic acid group content of each modified rubber is calculated by ¹H-NMR analysis.

### Examples and Comparative Examples

According to the amounts and groove depth D shown in the tables, the chemicals other than the sulfur and the vulcanization accelerators are kneaded in a 16-L Banbury mixer (Kobe Steel, Ltd.) at 160° C. for four minutes to obtain a kneaded mixture. Next, the kneaded mixture is kneaded with the sulfur and vulcanization accelerators using an open roll mill at 80° C. for four minutes to obtain an unvulcanized rubber composition. The unvulcanized rubber composition is formed into the shape of a tread and assembled with other tire components on a tire building machine to build an unvulcanized tire. The unvulcanized tire is vulcanized at 170° C. for 12 minutes, whereby a test tire (size: 195/65R15) is produced.

Test tires including rubber compositions prepared according to the formulations varied as shown in the tables are considered. The results calculated according to the methods of measuring the physical properties and evaluations described below are shown in the tables. Here, Comparative Example 1-1 is referred as a reference comparative example in Table 1, and Comparative Example 2-1 is referred as a reference comparative example in Table 2.

### <Viscoelastic Test>

A viscoelastic test sample having a length of 40 mm, a width of 3 mm, and a thickness of 0.5 mm is collected from the inside of a tread rubber layer in each test tire such that the longitudinal direction of the sample corresponds to the circumferential direction of the tire. The tan δ and E* of the tread rubber are measured under the conditions of a temperature of 30° C., an initial strain of 10%, a dynamic strain of 1%, a frequency of 10 Hz, an elongation mode, and a measurement duration of 30 minutes using a RSA series machine available from TA Instruments. A measurement value is obtained after 30 minutes from the start of the measurement.

The thickness direction of the sample corresponds to the radial direction of the tire.

<E* and Tan δ when Dry>

The viscoelastic test sample having a length of 40 mm, a width of 3 mm, and a thickness of 0.5 mm is dried at room temperature and normal pressure to a constant weight. The complex modulus of elasticity E* and the loss tangent tan δ of the dried vulcanized rubber composition (rubber piece) are measured by the above-described method in the viscoelastic test. The measured E* and tan δ are determined as E* and tan δ when dry, respectively.

<E* and Tan δ when Wet with Water>

The viscoelasticity is measured in water by the above-described method in the viscoelastic test using an immersion measurement jig of the RSA to determine the E* and tan δ. The temperature of the water is 30° C.

### <Wet Grip Performance>

The test tire is mounted on every wheel of a car (front-engine, front-wheel-drive car of 2000 cc displacement made in Japan). The braking distance of the car with an initial speed of 100 km/h on a wet asphalt road surface is determined and expressed as an index relative to the braking distance of the reference comparative example taken as 100. A higher index indicates better wet grip performance.

### <Dry Grip Performance>

The test tire is mounted on every wheel of a car (front-engine, front-wheel-drive car of 2000 cc displacement made in Japan). The braking distance of the car with an initial speed of 100 km/h on a dry asphalt road surface is determined and expressed as an index relative to the braking distance of the reference comparative example taken as 100. A higher index indicates better dry grip performance.

TABLE 1

| | | | | | | | | | Comparative |
|---|---|---|---|---|---|---|---|---|---|
| | | Example | | | | | | | Example |
| | | 1-1 | 1-2 | 1-3 | 1-4 | 1-5 | 1-6 | 1-7 | 1-1 |
| Amount | Carboxylic acid-modified SBR | 50 | 50 | 50 | 50 | 50 | 50 | — | — |
| (parts | Carboxylic acid-modified BR | — | — | — | — | — | — | — | — |
| by | NR | 10 | 10 | 10 | 10 | 10 | 10 | 10 | 10 |
| mass) | SBR | 20 | 20 | 20 | 20 | 20 | 20 | 70 | 70 |
| | BR | 20 | 20 | 20 | 20 | 20 | 20 | 20 | 20 |
| | Maleic acid-modified liquid IR | — | — | — | — | — | — | 30 | — |
| | Carbon black | 10 | 10 | 10 | 10 | 10 | 10 | 10 | 10 |
| | Silica | 65 | 65 | 75 | 90 | 65 | 65 | 65 | 65 |
| | Stearic acid | 2 | 2 | 2 | 2 | 2 | 2 | 2 | 2 |
| | Potassium acetate | 7.24 | 9.65 | 7.24 | 7.24 | — | 7.24 | 7.24 | 2 |
| | Calcium acetate | — | — | — | — | 11.66 | — | — | — |
| | Zinc oxide | — | — | — | — | — | — | — | 2.2 |
| | Oil | 10 | 10 | 10 | 10 | 10 | 10 | 10 | 10 |
| | Silane coupling agent | 5.2 | 5.2 | 6.0 | 7.2 | 5.2 | 5.2 | 5.2 | 5.2 |
| | Resin | 10 | 10 | 10 | 10 | 10 | 10 | 10 | 10 |
| | Antioxidant | 2.8 | 2.8 | 2.8 | 2.8 | 2.8 | 2.8 | 2.8 | 2.8 |
| | Sulfur | 1 | 1 | 1 | 1 | 1 | 1 | 1 | 1 |
| | Vulcanization accelerator DPG | 2.3 | 2.3 | 2.3 | 2.3 | 2.3 | 2.3 | 2.3 | 2.3 |
| | Vulcanization accelerator NS | 1.6 | 1.6 | 1.6 | 1.6 | 1.6 | 1.6 | 1.6 | 1.6 |
| Groove depth D [mm] of circumferential groove | | 8 | 8 | 8 | 8 | 8 | 10 | 8 | 8 |
| Results | E* when wet with water/E* when dry | 0.85 | 0.82 | 0.83 | 0.79 | 0.86 | 0.85 | 0.87 | 0.98 |
| | tan δ when wet with water/tan δ when dry | 1.17 | 1.19 | 1.19 | 1.24 | 1.17 | 1.17 | 1.21 | 1.00 |
| | E* [MPa] when dry | 4.6 | 4.9 | 5.4 | 7.1 | 4.9 | 4.6 | 4.1 | 4.3 |
| | tan δ when dry | 0.29 | 0.32 | 0.30 | 0.38 | 0.27 | 0.29 | 0.25 | 0.18 |
| | Groove depth D [mm] of circumferential | 9.4 | 9.8 | 9.6 | 10.1 | 9.3 | 11.8 | 9.2 | 8.2 |
| | groove/(E* when wet with water/E* when dry) | | | | | | | | |
| | Wet grip performance | 108 | 109 | 109 | 110 | 107 | 112 | 107 | 100 |
| | Dry grip performance | 103 | 104 | 103 | 104 | 102 | 104 | 103 | 100 |

TABLE 2

| | | | | | | | | | Corrparative |
|---|---|---|---|---|---|---|---|---|---|
| | | Example | | | | | | | Example |
| | | 2-1 | 2-2 | 2-3 | 2-4 | 2-5 | 2-6 | 2-7 | 2-1 |
| Amount | Carboxylic acid-modified SBR | — | — | — | — | — | — | — | — |
| (parts | Carboxylic acid-modified BR | 50 | 50 | 50 | 50 | 50 | 50 | — | — |
| by | NR | 10 | 10 | 10 | 10 | 10 | 10 | 10 | 10 |
| mass) | SBR | 20 | 20 | 20 | 20 | 20 | 20 | 20 | 20 |
| | BR | 20 | 20 | 20 | 20 | 20 | 20 | 70 | 70 |
| | Maleic acid-modified liquid IR | — | — | — | — | — | — | 30 | — |
| | Carbon black | 10 | 10 | 10 | 10 | 10 | 10 | 10 | 10 |
| | Silica | 65 | 65 | 75 | 90 | 65 | 65 | 65 | 65 |
| | Stearic acid | 2 | 2 | 2 | 2 | 2 | 2 | 2 | 2 |
| | Potassium acetate | 7.24 | 9.65 | 7.24 | 7.24 | — | 7.24 | 7.24 | — |
| | Calcium acetate | — | — | — | — | 11.66 | — | — | — |
| | Zinc oxide | — | — | — | — | — | — | — | 2.2 |
| | Oil | 10 | 10 | 10 | 10 | 10 | 10 | 10 | 10 |
| | Silane coupling agent | 5.2 | 5.2 | 6.0 | 7.2 | 5.2 | 5.2 | 5.2 | 5.2 |
| | Resin | 10 | 10 | 10 | 10 | 10 | 10 | 10 | 10 |
| | Antioxidant | 2.8 | 2.8 | 2.8 | 2.8 | 2.8 | 2.8 | 2.8 | 2.8 |
| | Sulfur | 1 | 1 | 1 | 1 | 1 | 1 | 1 | 1 |
| | Vulcanization accelerator DPG | 2.3 | 2.3 | 2.3 | 2.3 | 2.3 | 2.3 | 2.3 | 2.3 |
| | Vulcanization accelerator NS | 1.6 | 1.6 | 1.6 | 1.6 | 1.6 | 1.6 | 1.6 | 1.6 |
| Groove depth D [mm] of circumferential groove | | 8 | 8 | 8 | 8 | 8 | 10 | 8 | 8 |
| Results | E* when wet with water/E* when dry | 0.84 | 0.82 | 0.83 | 0.78 | 0.85 | 0.84 | 0.85 | 1.00 |
| | tan δ when wet with water/tan δ when dry | 1.18 | 1.20 | 1.18 | 1.23 | 1.17 | 1.18 | 1.20 | 1.00 |
| | E* [MPa] when dry | 3.7 | 3.9 | 4.1 | 5.7 | 3.9 | 3.7 | 3.4 | 3.3 |
| | tan δ when dry | 0.22 | 0.25 | 0.25 | 0.33 | 0.24 | 0.22 | 0.20 | 0.16 |
| | Groove depth D [mm] of circumferential | 9.5 | 9.8 | 9.6 | 10.3 | 9.4 | 11.9 | 9.4 | 8.0 |
| | groove/(E* when wet with water/E* when dry) | | | | | | | | |
| | Wet grip performance | 109 | 111 | 109 | 110 | 108 | 106 | 108 | 100 |
| | Dry grip performance | 104 | 105 | 106 | 107 | 102 | 101 | 104 | 100 |

As described above, the present disclosure (1) relates to a tire, including a tread with at least one circumferential groove,
the circumferential groove being formed of a groove-forming rubber composition,
E* (MPa) when wet with water, E* (MPa) when dry, tan δ when wet with water, and tan δ when dry of the groove-forming rubber composition and groove depth D (mm) of the circumferential groove satisfying at least one of the following formula (1-1) or the following formula (1-2) as well as the following formula (2):

$$E * when wet with water / E * when dry \leq 0.9 \qquad ( 1 - 1 )$$

$$tan δ when wet with water / tan δ when dry \geq 1.1 \qquad ( 1 - 2 )$$

$$D / ( E * when wet with water / E * when dry ) > 9. \qquad ( 2 )$$

where E* and tan δ represent a complex modulus of elasticity (MPa) and a loss tangent, respectively, after 30 minutes from the start of measurement under the conditions of a temperature of 30° C., an initial strain of 10%, a dynamic strain of 1%, a frequency of 10 Hz, an elongation mode, and a measurement duration of 30 minutes, and D represents the groove depth (mm) of the circumferential groove.

The present disclosure (2) is the tire according to the present disclosure (1),
wherein the groove-forming rubber composition satisfies the following formula:

E*when wet with water/E*when dry≤0.85.

The present disclosure (3) is the tire according to the present disclosure (1) or (2),
wherein the groove-forming rubber composition satisfies the following formula:

tan δ when wet with water/tan δ when dry≤1.15.

The present disclosure (4) is the tire according to any one of the present disclosures (1) to (3),
wherein the E* when dry of the groove-forming rubber composition is 2.5 MPa or more.

The present disclosure (5) is the tire according to any one of the present disclosures (1) to (4),
wherein the tan δ when dry of the groove-forming rubber composition is 0.15 or more.

The present disclosure (6) is the tire according to any one of the present disclosures (1) to (5),
wherein the groove-forming rubber composition contains:
a modified rubber containing at least one selected from the group consisting of carboxylic acid, sulfonic acid, and salts thereof in its molecule; and
at least one alkali metal salt or alkaline earth metal salt selected from the group consisting of lithium carbonate, sodium carbonate, potassium carbonate, rubidium carbonate, cesium carbonate, beryllium carbonate, magnesium carbonate, calcium carbonate, strontium carbonate, barium carbonate, lithium acetate, sodium acetate, potassium acetate, rubidium acetate, cesium acetate, beryllium acetate, magnesium acetate, calcium acetate, strontium acetate, barium acetate, lithium phenoxide, sodium phenoxide, potassium phenoxide, rubidium phenoxide, cesium phenoxide, beryllium diphenoxide, magnesium diphenoxide, calcium diphenoxide, strontium diphenoxide, and barium diphenoxide.

The present disclosure (7) is the tire according to the present disclosure (6),
wherein the groove-forming rubber composition contains the modified rubber in an amount of 5 to 90% by mass based on 100% by mass of a rubber component therein.

The present disclosure (8) is the tire according to the present disclosure (6) or (7),
wherein the groove-forming rubber composition contains the alkali metal salt or alkaline earth metal salt in an amount of 0.5 to 20.0 parts by mass per 100 parts by mass of the rubber component.

The present disclosure (9) is the tire according to any one of the present disclosures (6) to (8),
wherein the modified rubber containing at least one selected from the group consisting of carboxylic acid, sulfonic acid, and salts thereof in its molecule is an emulsion polymerized styrene-butadiene rubber containing methacrylic acid in its molecule.

The present disclosure (10) is the tire according to any one of the present disclosures (6) to (9),
wherein the alkali metal salt or alkaline earth metal salt includes at least one of potassium acetate or calcium acetate.

The present disclosure (11) is the tire according to any one of the present disclosures (1) to (5),
wherein the groove-forming rubber composition contains:
a modified liquid diene-based polymer containing at least one selected from the group consisting of carboxylic acid, sulfonic acid, and salts thereof in its molecule; and
at least one alkali metal salt or alkaline earth metal salt selected from the group consisting of lithium carbonate, sodium carbonate, potassium carbonate, rubidium carbonate, cesium carbonate, beryllium carbonate, magnesium carbonate, calcium carbonate, strontium carbonate, barium carbonate, lithium acetate, sodium acetate, potassium acetate, rubidium acetate, cesium acetate, beryllium acetate, magnesium acetate, calcium acetate, strontium acetate, barium acetate, lithium phenoxide, sodium phenoxide, potassium phenoxide, rubidium phenoxide, cesium phenoxide, beryllium diphenoxide, magnesium diphenoxide, calcium diphenoxide, strontium diphenoxide, and barium diphenoxide.

The present disclosure (12) is the tire according to the present disclosure (11),
wherein the groove-forming rubber composition contains the modified liquid diene-based polymer in an amount of 5 to 50 parts by mass per 100 parts by mass of the rubber component.

The present disclosure (13) is the tire according to the present disclosure (11) or (12),
wherein the groove-forming rubber composition contains the alkali metal salt or alkaline earth metal salt in an amount of 0.5 to 20.0 parts by mass per 100 parts by mass of the rubber component.

The present disclosure (14) is the tire according to any one of the present disclosures (11) to (13),
wherein the modified liquid diene-based polymer containing at least one selected from the group consisting of carboxylic acid, sulfonic acid, and salts thereof in its molecule is a liquid isoprene polymer containing methacrylic acid or maleic acid in its molecule.

The present disclosure (15) is the tire according to any one of the present disclosures (11) to (14),
wherein the alkali metal salt or alkaline earth metal salt includes at least one of potassium acetate or calcium acetate.

### REFERENCE SIGNS LIST

2 pneumatic tire
4 tread
6 sidewall
8 wing
10 clinch
12 bead
14 carcass
16 belt
18 band
20 innerliner
22 chafer
24 tread face
26 circumferential groove
27 groove bottom
28 base layer
30 cap layer
32 core
34 apex
36 carcass ply
36a main portion
36b folded portion
38 interior layer
40 exterior layer
44 rib
CL equator of tire 2
D groove depth of circumferential groove

1. A tire, comprising a tread with at least one circumferential groove,
the circumferential groove being formed of a groove-forming rubber composition,
E* (MPa) when wet with water, E* (MPa) when dry, tan δ when wet with water, and tan δ when dry of the groove-forming rubber composition and groove depth D (mm) of the circumferential groove satisfying at least one of the following formula (1-1) or the following formula (1-2) as well as the following formula (2):
$$E * when wet with water / E * when dry \leq 0.9 \qquad ( 1 - 1 )$$
$$tan δ when wet with water / tan δ when dry \geq 1.1 \qquad ( 1 - 2 )$$
$$D / ( E * when wet with water / E * when dry ) > 9. \qquad ( 2 )$$
where E* and tan δ represent a complex modulus of elasticity (MPa) and a loss tangent, respectively, after 30 minutes from the start of measurement under the conditions of a temperature of 30° C., an initial strain of 10%, a dynamic strain of 1%, a frequency of 10 Hz, an elongation mode, and a measurement duration of 30 minutes, and D represents the groove depth (mm) of the circumferential groove.

2. The tire according to claim 1,
wherein the groove-forming rubber composition satisfies the following formula:
E*when wet with water/E*when dry≤0.85.

3. The tire according to claim 1,
wherein the groove-forming rubber composition satisfies the following formula:
tan δ when wet with water/tan δ when dry≥1.15.

4. The tire according to claim 1,
wherein the E* when dry of the groove-forming rubber composition is 2.5 MPa or more.

5. The tire according to claim 1,
wherein the tan δ when dry of the groove-forming rubber composition is 0.15 or more.

6. The tire according to claim 1,
wherein the groove-forming rubber composition comprises:
a modified rubber comprising at least one selected from the group consisting of carboxylic acid, sulfonic acid, and salts thereof in its molecule; and
at least one alkali metal salt or alkaline earth metal salt selected from the group consisting of lithium carbonate, sodium carbonate, potassium carbonate, rubidium carbonate, cesium carbonate, beryllium carbonate, magnesium carbonate, calcium carbonate, strontium carbonate, barium carbonate, lithium acetate, sodium acetate, potassium acetate, rubidium acetate, cesium acetate, beryllium acetate, magnesium acetate, calcium acetate, strontium acetate, barium acetate, lithium phenoxide, sodium phenoxide, potassium phenoxide, rubidium phenoxide, cesium phenoxide, beryllium diphenoxide, magnesium diphenoxide, calcium diphenoxide, strontium diphenoxide, and barium diphenoxide.

7. The tire according to claim 6,
wherein the groove-forming rubber composition comprises the modified rubber in an amount of 5 to 90% by mass based on 100% by mass of a rubber component therein.

8. The tire according to claim 6,
wherein the groove-forming rubber composition comprises the alkali metal salt or alkaline earth metal salt in an amount of 0.5 to 20.0 parts by mass per 100 parts by mass of the rubber component.

9. The tire according to claim 6,
wherein the modified rubber comprising at least one selected from the group consisting of carboxylic acid, sulfonic acid, and salts thereof in its molecule is an emulsion polymerized styrene-butadiene rubber comprising methacrylic acid in its molecule.

10. The tire according to claim 6,
wherein the alkali metal salt or alkaline earth metal salt comprises at least one of potassium acetate or calcium acetate.

11. The tire according to claim 1,
wherein the groove-forming rubber composition comprises:
a modified liquid diene-based polymer comprising at least one selected from the group consisting of carboxylic acid, sulfonic acid, and salts thereof in its molecule; and
at least one alkali metal salt or alkaline earth metal salt selected from the group consisting of lithium carbonate, sodium carbonate, potassium carbonate, rubidium carbonate, cesium carbonate, beryllium carbonate, magnesium carbonate, calcium carbonate, strontium carbonate, barium carbonate, lithium acetate, sodium acetate, potassium acetate, rubidium acetate, cesium acetate, beryllium acetate, magnesium acetate, calcium acetate, strontium acetate, barium acetate, lithium phenoxide, sodium phenoxide, potassium phenoxide, rubidium phenoxide, cesium phenoxide, beryllium diphenoxide, magnesium diphenoxide, calcium diphenoxide, strontium diphenoxide, and barium diphenoxide.

12. The tire according to claim 11,
wherein the groove-forming rubber composition comprises the modified liquid diene-based polymer in an amount of 5 to 50 parts by mass per 100 parts by mass of the rubber component.

13. The tire according to claim 11,
wherein the groove-forming rubber composition comprises the alkali metal salt or alkaline earth metal salt in an amount of 0.5 to 20.0 parts by mass per 100 parts by mass of the rubber component.

14. The tire according to claim 11,
wherein the modified liquid diene-based polymer comprising at least one selected from the group consisting of carboxylic acid, sulfonic acid, and salts thereof in its molecule is a liquid isoprene polymer comprising methacrylic acid or maleic acid in its molecule.

15. The tire according to claim 11,
wherein the alkali metal salt or alkaline earth metal salt comprises at least one of potassium acetate or calcium acetate.
